(19) United States
(12) Patent Application Publication
(10) Pub. No.: US 2011/0207564 A1
(43) Pub. Date: Aug. 25, 2011

(54) BALL HAVING MODIFIED SURFACES FOR TRAINING

(76) Inventors: Corey Goodall, New York, NY (US); Natasha Goodall, New York, NY (US); Quiana McCook, White Plains, NY (US)

(21) Appl. No.: 12/712,277

(22) Filed: Feb. 25, 2010

(51) Int. Cl. A63B 43/00; A63B 41/02; A63B 45/00; B29D 22/02

(52) U.S. Cl. 473/595; 473/614; 264/574

(57) ABSTRACT

A ball having a modified surface for training includes an inflatable bladder that includes an inner surface that defines an inflation chamber and an outer ground contacting layer that is disposed on an outer surface of the bladder. The ground contacting layer includes at least one protrusion that is formed during the manufacture of the ball. The protrusion extends radially outward from surrounding portions of the ground contacting layer so as to create a local modified surface area that imparts different bounce properties (bounding pattern) to the ball than the surrounding ground contacting layer portions, thereby causing the ball to have an unpredictable bounding pattern depending upon which portion of the ball strikes the ground.

### TECHNICAL FIELD

The present invention relates to sports equipment and more particularly, relates to a ball that is configured to increase the skill of a player by imparting an unpredictable random bounding pattern that exercises and improves a player's reaction speed and hand eye coordination.

### BACKGROUND

A ball is a round object with various uses. A ball is usually spherical but it can also be ovoid. It is used in ball games, where the play of the game follows the state of the ball as it is hit, kicked or thrown by players. There are a vast number of different types of balls including different sized balls, different colored balls, different shaped balls, and balls formed of different materials. For example, there are different types of balls for children's play as well as balls that are meant to be used in organized games, including professional ball games. Some of the more common and popular ball games are baseball, football, soccer, volleyball, basketball, etc.

In the game of basketball, two teams of 5 players each try to score points against one another by placing a ball through a 10 foot high hoop under organized rules. Basketball is very popular across the world and is played by millions on local basketball courts, elementary and secondary schools, colleges, etc. Points are scored by throwing (shooting) the ball through the basket from above. The team with more points at the end of the game wins, but additional time (overtime) may be issued when the scores of both teams are the same. The ball can be advanced on the court by bouncing it (dribbling) or passing it between teammates.

A basketball is an inflated ball used in the game of basketball. A basketball is an inflated ball used in the game of basketball. Nearly all basketballs have an inflatable inner rubber bladder, generally wrapped in layers of fiber and then covered with a tacky surface made either from leather (traditional), rubber, or a synthetic composite. As in most inflatable balls, there is a small opening to allow the pressure to be increased or decreased.

The surface of the ball is nearly always divided by “ribs” that are recessed below the surface of the ball in a variety of configurations and are generally a contrasting color. An orange surface with black ribs and a possible logo is the traditional colour scheme of basketballs but they are sold in various colors.

Balls are generally designated for indoor (generally made of leather or absorbent composites), or all-surface use (generally made of rubber or durable composites, also known as Indoor/Outdoor balls). Indoor balls tend to be considerably more expensive than all-surface balls due to cost of materials. In addition, brand new all-leather indoor balls must be “broken in” first to achieve optimal grip before use in competition. The abrasiveness of asphalt and the dirt and moisture generally present in an outdoor setting will usually ruin an indoor ball within a very short period of time, which is why an indoor/outdoor ball is recommended for recreational players.

As previously mentioned, one of the skills that has to be mastered in the play of basketball is the act of dribbling the ball in a manner that an opponent can not easily take the ball away (steal) from the dribbling player. In order to assist a player in becoming a better dribbler, there are aides and/or exercises available to assist the player. Some of the dribbling aids that are currently available are weighted basketballs, basketball handling gloves, and googles to name a few. While these products may provide some benefits, there is a need to provide a dribbling aid that increases the skills of a player by improving and increasing the player's reaction time and hand eye coordination skills.

### SUMMARY

A ball having a modified surface for training includes an inflatable bladder that includes an inner surface that defines an inflation chamber and an outer ground contacting layer that is disposed on an outer surface of the bladder. The ground contacting layer includes at least one protrusion that is formed during the manufacture of the ball. The protrusion extends radially outward from surrounding portions of the ground contacting layer so as to create a local modified surface area that imparts different bounce properties to the ball than the surrounding ground contacting layer portions, thereby causing the ball to have an unpredictable bounding (bounce) pattern depending upon which portion of the ball strikes the ground.

In another embodiment, a ball having a modified surface for training includes an inflatable bladder that includes an inner surface that defines an inflation chamber and an outer ground contacting layer that is disposed on an outer surface of the bladder. The ground contacting layer has a first radius of curvature when the ball is inflated. The ball also includes at least one surface modifying member that is configured to be securely adhered to the outer ground contacting layer in a pre-selected location. The surface modifying member has an inner surface that includes an adhesive layer for securely adhering the surface modifying member to the outer ground contacting layer. The surface modifying member has an arcuate outer surface, wherein a thickness of the surface modifying member is greatest in a center thereof with peripheral edges thereof being tapered.

These and other aspects, features and advantages shall be apparent from the accompanying Drawings and description of certain embodiments of the invention.

### BRIEF DESCRIPTION OF THE DRAWINGS

FIG. 1 is a perspective view of a ball according to one embodiment of the present invention;

FIG. 2 is a cross-sectional view of a portion of the ball that includes the surface modifying member according to a first embodiment of the present invention;

FIG. 3 is a cross-sectional view of a portion of the ball that includes the surface modifying member according to a second embodiment of the present invention;

FIG. 4 is a cross-sectional view of a portion of the ball that includes the surface modifying member according to a third embodiment of the present invention;

FIG. 5 is a cross-sectional view of a portion of the ball that includes the surface modifying member according to a fourth embodiment of the present invention;

FIG. 6 is a perspective view of a ball according to another embodiment of the present invention showing several different surface modifying members being part of the ball;

FIG. 7 is a perspective view of a first customized surface modifying member; and

FIG. 8 is a perspective view of a second customized surface modifying member.

### DETAILED DESCRIPTION OF CERTAIN EMBODIMENTS OF THE INVENTION

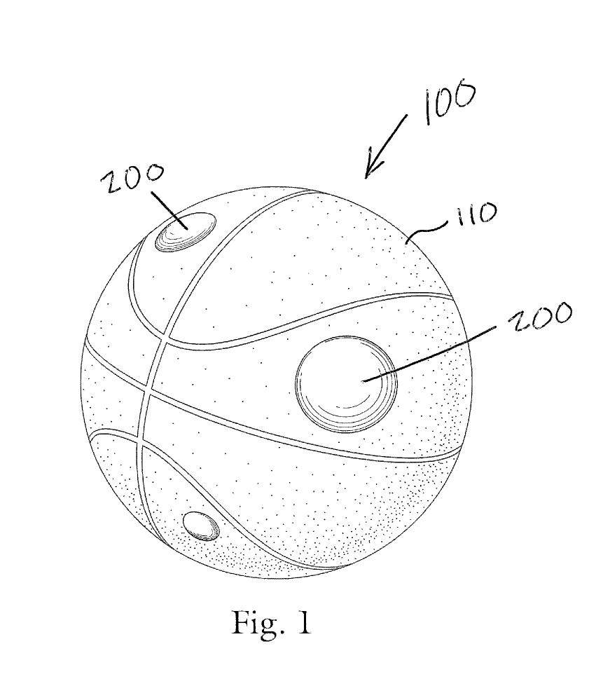

FIG. 1 illustrates a ball 100 having a modified surface for training according to one embodiment. The ball 100 can be any number of different types of balls that are intended to be bounced during the play of a game. The ball 100 is a substantially spherical body that has an outer ground contact surface 110.

In one embodiment the ball 100 is a basketball. Organized basketball leagues generally have very rigorous specifications for the balls to be used in official competition including the weight, inflation pressure, bounce, circumference, color, and materials used. Most leagues use very similar specifications for their balls which are referred to as size 7 (for men's competition) and size 6 (for women's competition) by manufacturers. The elite and most well known basketball league, namely, the National Basketball Association (NBA) allows only one official ball: The ball must be the official NBA game ball manufactured by Spalding. The ball is orange in color, 29.5 inches in circumference and weighs 22 ounces (size 7). It must also be inflated to between 7.5 and 8.5 pounds per square inch. While the league briefly used a new ball that had a synthetic surface and a modified rib pattern, there were many compliants and dissatisfaction amongst the players and as a result, the NBA decided to revert to the old leather ball.

In accordance with the present invention, the ball 100 is modified so that it acts as a training aid by providing an unpredictable random bounding (bounce) pattern when the ball 100 strikes the ground surface for exercising and improving a player's reaction speed and hand eye coordination.

For example, the ball 100 has at least one and preferably two or more modified surfaces 200 that locally alter the surface characteristics (e.g., radius of curvature) of the outer surface 110 of the ball 100 in discrete regions of the ball. As shown in FIG. 1, the surface modifications 200 can be provided about the outer surface 110 in a random pattern.

In one embodiment, the surface modifications 200 are in the form of pre-formed local protrusions that cause the ball 100 to have a non-uniform outer surface 110. More specifically, the protrusions 200 alter the radius of curvature of the ball 100 in local areas of the ball and appear as bulges or the like. Typically, the radius of curvature of a conventional ball is substantially uniform.

By locally altering (e.g., the radius of curvature) the outer surface 110 in local areas, the one or more protrusions 200 impart to the ball 100 an unpredictable random bounding pattern depending upon which area of the outer surface 110 contacts the ground. For example, if the ball 100 contacts the ground surface in an area that lacks protrusion 200, then the ball 100 will act in a conventional manner in terms of its bounding pattern. However, if the ball 100 contacts the ground in an area where protrusion 200 is formed, then the bounding pattern of the ball 100 will not be conventional and but rather, an unpredictable random bounding pattern will result. The uncertainty of how the ball 100 will react when contacting the ground surface as during normal bouncing (dribbling) causes the player to be more on top of his or her game since additional skill is needed to control the ball. This results in sharpening of the player's skills (e.g., player's reaction speed) and especially, improves the hand eye coordination of the player.

The formation of the surface modifications 200 is described below. In a first embodiment, the surface modifications 200 (protrusions) are pre-formed during the manufacture of the ball 100. For example, as previously mentioned, one type of ball 100 has an inflatable inner rubber bladder 300, generally wrapped in layers of fiber and then covered with a tacky outer surface 110 as shown in FIG. 1. For simplicity, the figures illustrate the element 300 as a single layer; however, it will be understood that the element 300 can be formed of several combined layers, such as the bladder, fibers, and tacky material. The rubber bladder 300 has an inner surface 310 that defines a hollow interior inflation chamber 320 which receives a gas (air) for inflation of the ball 100.

The rubber bladder 300 can be formed using any number of different processing techniques, including but not limited to a molding process, etc. As is known, a molding process uses a mold which is a hollowed-out block that is filled with a liquid like material, such as a plastic, (in this case, rubber) and the liquid hardens or sets inside the mold, adopting its shape. In the case of making a ball 100, the mold has a spherical shape so as to form the rubber bladder 300 and define the hollow interior inflation chamber 320.

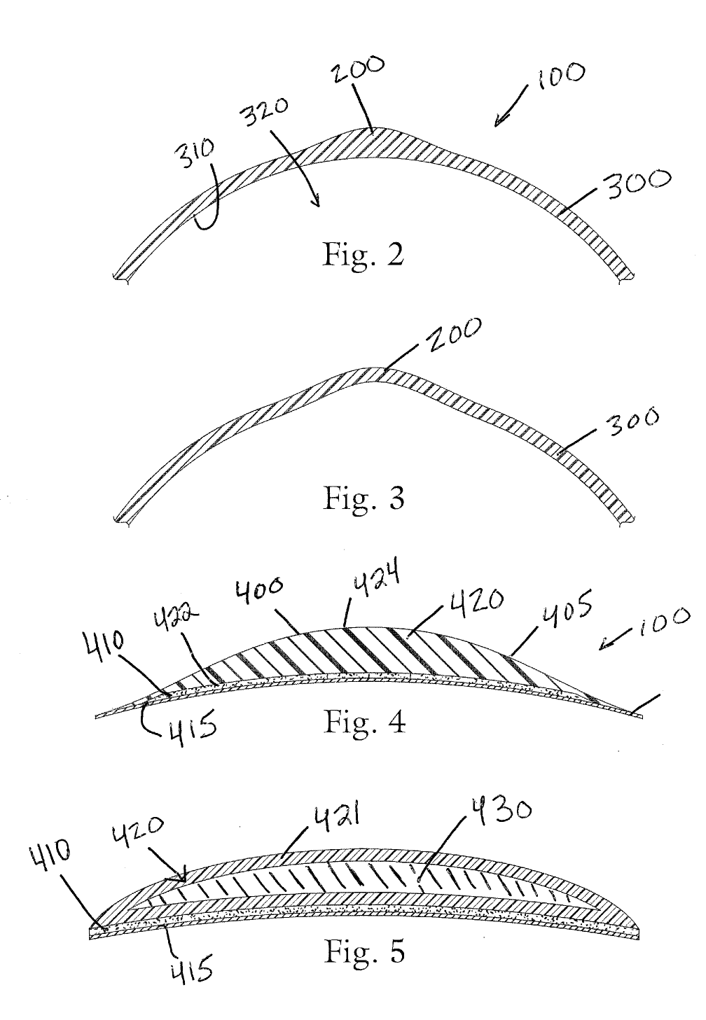

In accordance with the present invention, the mold is modified compared to a conventional mold used to form a uniformly spherical ball. In particular, the mold is modified so that the local protrusions (areas with different radiuses of curvature) are formed along the outer surface 110 of the ball 100. In one embodiment, shown in FIG. 2, the hollow interior inflation chamber 100 is uniform and is the same as with a conventional ball in that when inflated, the inner surface of the rubber bladder 300 defines a spherical space. Instead, the mold is formed so that in the local areas where the protrusions 200 are formed, the thickness of the ball 100 is not uniform but rather, these local areas have an increased thickness. This can result from the outer die of the mold having a recessed depression where additional liquid material flows into during the manufacturing process resulting in the ball 100 having an increased thickness in these local areas. It will be appreciated that in these local areas, as a result of the increased thickness of the rubber bladder 300, a local protrusion is formed and the radius of curvature of the ball 100 can be different in this local area compared to the surrounding uniform sections of the ball 100.

The characteristics of the protrusion, such as the thickness and/or the value of the radius of curvature, can be varied by simply changing the characteristics of the mold die and more particularly, by changing the depth of the recessed protrusion that is formed in the die. An increased depth will result in the protrusion 200 having a greater radius of curvature, while a decreased depth will result in the protrusion 200 having a lesser radius of curvature.

While, it is expected that the protrusion 200 has a circular shape to allow the protrusion to smoothly blend into the overall spherical shape of the ball 100, the present invention is not limited to having a circular shaped protrusion 200.

It will be appreciated that in this first embodiment, the thickness of the rubber bladder 300 is not uniform but rather the rubber bladder 300 has local areas of increased thickness where the protrusions 200 are formed.

In a second embodiment, the rubber bladder 300 has a uniform thickness; however, the shape of the hollow interior inflation chamber is not uniform (spherical) as in the first embodiment. Instead, the mold is formed so that both the inner and outer mold dies have modified areas where the protrusions 200 are formed. In these areas, the local areas of the mold that are non-uniform cause the interior inflation chamber to have extra pockets of inflation space (e.g., hemi-spherically shaped pockets or crater formed along the inner surface 310) such that when the ball 100 is properly inflated, air flows into and inflates the pockets that are formed outward from the main central spherically shaped inflation chamber. When the ball is properly inflated, the protrusions 200 are likewise properly inflated causing the ball to have the local protrusions 200 that alter the bounce characteristics of the ball 100 when impacted.

It will be appreciated that in the second embodiment, the rubber bladder 300 has a uniform thickness and the protrusions 200 are instead formed by altering the shape of the interior inflation chamber.

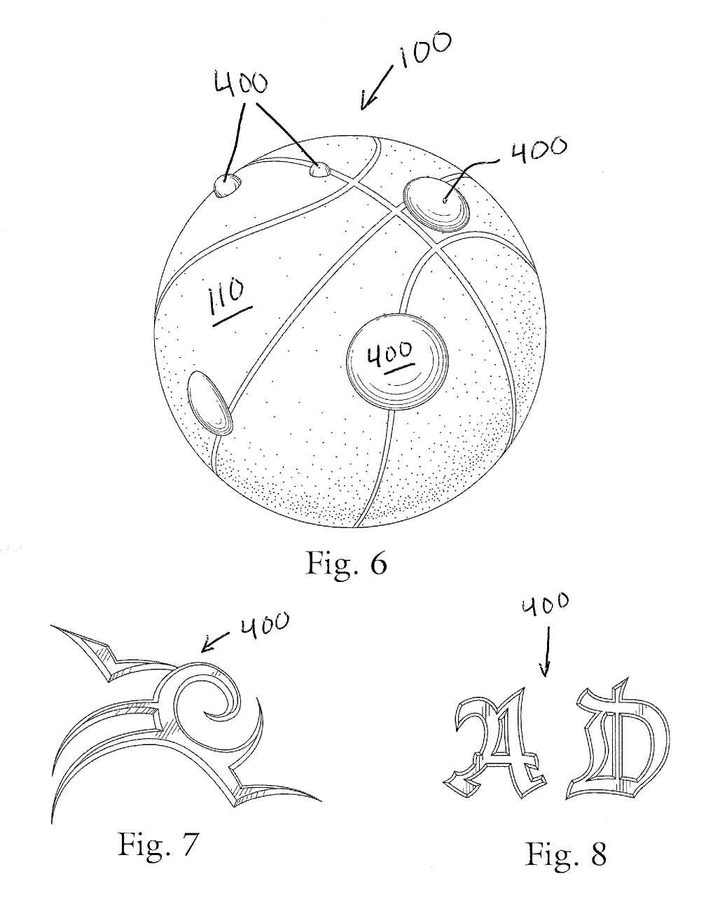

In yet another embodiment shown in FIGS. 4-6, the ball 100 includes surface modifications (protrusions) 400 that are formed using a different process and in particular, the protrusions 400 are not formed as an integral part of the rubber bladder 300 during the manufacturing process. Instead, the protrusions 400 are adhesive based members that can be securely adhered to the outer surface 110 of the ball 100.

It will be appreciated that the protrusions disclosed herein can have a saddle shape in that is has a concave surface along its length and likewise has a concave surface along its width.

FIG. 4 shows the protrusion 400 according to one embodiment that is suitable for securely adhering to the outer surface 110. The protrusion 400 has a body 405 that is formed of multiple layers. The protrusion 400 can include an adhesive layer 410 and a base layer 420. The base layer 420 includes an inner surface 422 and an opposing outer surface 424. The adhesive layer 410 is disposed along the inner surface 422. The adhesive layer 410 is formed of an adhesive material that is suitable for use in the intended application of the present invention. The adhesive material provides a secure attachment of the protrusion 400 to the outer surface 110 of the ball 100 using a bond that is capable of withstanding the ordinary use of the ball 100 and more specifically, can withstand the bouncing of the ball 100 against the ground surface.

A release cover 415 is disposed on the adhesive layer 410 and is removed just prior to the protrusion 400 being adhered to the outer surface 110.

In the embodiment of FIG. 4, the base layer 420 is formed of one material and is homogenous in nature.

The outer surface 424 of the base layer 420 causes the outer surface 110 of the ball 100 to have a different radius of curvature than the surrounding radius of curvature that defines the portions of the ball 100 that are free of the protrusions 400.

In one embodiment, the base layer 420 is formed of a first material that is different from the material that is used to form the rubber bladder 300. By altering the material of the base layer 420, the bounding pattern of the ball can be altered and in particular, the bounding pattern of the ball 100 is rendered unpredictable when the ball strikes the ground surface with the protrusion 400 at least partially contacting the ground surface.

For example, the base layer 420 can be formed of a softer material (lesser durometer) which causes a reduction in the bounce potential of the ball when the ball contacts the ground surface with the protrusion 400 at least partially contacting the ground surface.

Alternatively, the base layer 420 can be formed of a harder material (greater durometer) which causes an increase in the bounce potential of the ball when the ball contacts the ground surface with the protrusion 400 at least partially contacting the ground surface.

In yet another embodiment, shown in FIG. 5, the base layer 420 is not a homogenous layer but rather the base layer 420 is formed of more than one material. For example, the base layer 420 can include an outer skin or outer layer 421 that is formed of one material and an inner layer 430 that is formed of a different material. For example, the outer layer 421 can be a rubber skin layer, while the inner layer 430 is formed of a material that has different material characteristics that the outer layer 421. For example, the outer layer 421 is a solid layer, while the inner layer 430 can be a semi-solid material, a gel, a liquid, etc. It will also be appreciated that instead of the element 430 being a material layer, it can be a cavity (defined by the outer layer 421, that contains a gas, such as air or another gas.

In the event that the inner layer 430 is formed of a liquid or gel, the bounce potential is reduced in this local area that is encompassed by the protrusion 400. This results in an unpredictable bounding pattern. The inner layer 430 can also be formed of a solid material that is different than the material that forms the outer layer 421. For example, the inner layer 430 can be a foam material or the like that similar to the use of a gel causes a reduction in the bounce potential of the ball when the ball strikes the ground surface with at least a portion of the protrusion 400 striking the ground surface.

Alternatively, the base layer 420 is formed of the same material as the material that is used to form the rubber bladder 300. In this embodiment, the base layer 420 functions as a surface modifying feature since it alters the bounding pattern of the ball when the ball strikes the ground surface. For example, the base layer 420 can be formed of a rubber material.

In yet another embodiment, the protrusion 400 can be formed of a compressible material, while in another embodiment, the protrusion 400 can be formed of a noncompressible material. When the ball 100 contains these two different types of protrusions, different bounding properties can be realized since each protrusion 400 has different bounding properties due to the difference in the material and in particular, the difference in material compression.

In the illustrated embodiments, the protrusion, both the pre-formed type and the adhesive type, has a stretched or flattened parabolic shape in that the edges of the protrusion blend smoothly with the outer surface 110 of the ball 100 in the surrounding areas where the outer surface 110 has a uniform shape (uniform radius of curvature).

It will also be appreciated that when the ball includes more than one protrusion or the like for locally altering the outer surface characteristics of the ball, two or more different types of protrusions can be used. For example, one protrusion can be an adhesive type that is formed of a homogenous material (e.g., a rubber adhesive based protrusion), while another protrusion can be an adhesive type that has a gel inner layer.

It will also be appreciated that at least one protrusion can be of an adhesive type, while at least one can be of the pre-formed type that is formed during the ball manufacturing process.

In yet another embodiment, the protrusion 400 is not adhered to the outer surface 110 of the ball 100 using an adhesive bond, but rather, the protrusion 400 can be coupled to the ball 100 using other coupling means including the use of an elastic cord or the like that can be fitted within a groove that is typically present in the outer surface 110 of the ball 100. In this manner, the protrusion is “strapped on” the outer surface 110 of the ball 100.

It will also be appreciated that the shape of the protrusion 400 can be customizable and is not limited to a circular shape or other regular shape. For example, the protrusion 400 can be in the form of letters (FIG. 8) so as to allow a user's initials to be adhered to the outer surface 110 of the ball 100. In addition, the protrusion 400 can have a shape that is in the form of a team's logo so as to permit a user to place his or her favorites team's logo on the ball while still providing the desired training tool. The protrusion 400 can thus provide a graphic display (FIG. 7).

In addition, the color of the protrusion 400 can be customizable and be different from the ball itself. This will permit the ball 100 to be customized. For example, the protrusion 400 can have multiple colors.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A ball having a modified surface for training comprising:
an inflatable bladder that includes an inner surface that defines an inflation chamber,
an outer ground contacting layer that is disposed on an outer surface of the bladder; and
wherein the ground contacting layer includes at least one protrusion that is formed during the manufacture of the ball, the protrusion extending radially outward from surrounding portions of the ground contacting layer so as to create a local modified surface area that imparts different bounce properties to the ball than the surrounding ground contacting layer portions, thereby causing the ball to have an unpredictable bounding pattern depending upon which portion of the ball strikes the ground.

2. The ball of claim 1, wherein the ground contacting layer includes two or more protrusions spaced apart from one another.

3. The ball of claim 1, wherein the bladder is a rubber bladder and the inflation chamber is spherically shaped.

4. The ball of claim 1, wherein inflation chamber is substantially spherically shaped except for the local area that contains the protrusion where an inflation pocket is formed as part of the inflation chamber to allow inflation of the ball such that the protrusion is defined.

5. The ball of claim 1, wherein the rubber bladder has a substantially uniform thickness.

6. The ball of claim 1, wherein the bladder has a substantially uniform thickness except for the local area that contains the protrusion where the bladder has an increased thickness to define the protrusion.

7. The ball of claim 1, wherein the ground contacting layer comprises a tacky surface.

8. The ball of claim 1, wherein the ground contacting layer has a first radius of curvature when the ball is inflated and the protrusion is defined by a second radius of curvature that is different from the first radius of curvature.

9. The ball of claim 1, wherein the protrusion has a greater thickness in a central portion thereof.

10. A ball having a modified surface for training comprising:
an rubber bladder that includes an inner surface that defines an inflation chamber,
an outer ground contacting layer that is disposed on an outer surface of the bladder, the ground contacting layer having a first radius of curvature when the ball is inflated; and
at least one surface modifying member that is configured to be securely adhered to the outer ground contacting layer in a pre-selected location, the surface modifying member having an inner surface that includes an adhesive layer for securely adhering the surface modifying member to the outer ground contacting layer, the surface modifying member having an arcuate outer surface, wherein a thickness of the surface modifying member is greatest in a center thereof with peripheral edges thereof being tapered.

11. The ball of claim 10, wherein the surface modifying member is separate from the ball.

12. The ball of claim 10, wherein the surface modifying member is formed of a substantially homogenous material.

13. The ball of claim 10, wherein the surface modifying member is formed of two different materials with one material forming an outer layer and the other material forming a core that is surrounded by the outer layer.

14. The ball of claim 13, wherein the material forming the core is more compressible than the material forming the outer layer.

15. The ball of claim 13, wherein the outer layer is a solid, while the core is one of a liquid and gel.

16. The ball of claim 13, wherein the tapered peripheral edges smoothly transition into the outer surface of the ball.

17. The ball of claim 13, wherein the surface modifying member has a saddle shape.

18. The ball of claim 13, wherein a color of the surface modifying surface is different than a color of the outer surface of the ball.

19. A method for forming a ball having a modified surface comprising the steps of:
providing a mold;
forming an inflatable bladder by disposing material into the mold, the bladder including an inner surface that defines an inflation chamber, wherein the mold is configured so that a ground contacting surface of the ball includes at least one protrusion that is formed during the molding process, the protrusion extending radially outward from surrounding portions of the ground contacting layer so as to create a local modified surface area that imparts different bounce properties to the ball than the surrounding ground contacting layer portions, thereby causing the ball to have an unpredictable bounding pattern depending upon which portion of the ball strikes the ground.

20. The method of claim 19, wherein the mold is configured so that the formed bladder has a locally increased thickness to define the protrusion.

21. The method of claim 19, wherein the mold is configured so that an inner surface of the bladder includes a crater to define the protrusion.
